(19) United States
(12) Patent Application Publication
(10) Pub. No.: US 2024/0422659 A1
(43) Pub. Date: Dec. 19, 2024

(54) MEASUREMENT REPORT CALIBRATION FOR USER EQUIPMENT (UE) STEERING IN WIRELESS COMMUNICATION NETWORKS

(71) Applicant: T-MOBILE INNOVATIONS LLC, Overland Park, KS (US)

(72) Inventor: Muhammad Tawhidur Rahman, Sammamish, WA (US)

(21) Appl. No.: 18/333,789

(22) Filed: Jun. 13, 2023

(51) Int. Cl. H04W 48/18; H04W 24/10

(52) U.S. Cl. CPC H04W 48/18; H04W 24/10

(57) ABSTRACT

Various embodiments comprise a wireless access node configured to steer a wireless user device to a RAT type. The wireless access node comprises radio circuitry and node circuitry. The radio circuitry receives a measurement report from a wireless user device for a first RAT type and a second RAT type. The sampling rate for the first measured signal strength is different than the sampling rate for the second measured signal strength. The node circuitry applies a calibration factor to the second measured signal strength to normalize the second measured signal strength with the first measured signal strength. The node circuitry compares the normalized second measured signal strength to the first measured signal strength. The radio circuitry wirelessly transfers an attachement instruction to the wireless user device to attach to the first RAT type or the second RAT type based on the comparison.

### TECHNICAL FIELD

Various embodiments of the present technology relate to User Equipment (UE) steering, and more specifically, to calibrating measurement reports received for different Radio Access Technology (RAT) types.

### BACKGROUND

Wireless communication networks provide wireless data services to wireless user devices. Exemplary wireless data services include machine-control, internet-access, media-streaming, online gaming, and social-networking. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

The RANs provide wireless service to wireless user devices in geographic regions referred to as sectors. When a wireless user device moves from a sector served by a first RAN to a sector served by a second RAN, the wireless user device detaches from the first RAN and attaches to the second RAN in a process referred to as handover. To detect handover conditions, the wireless user device measures received signal strength of nearby RANs and generates a measurement report that characterizes measured signal strengths and transfers the measurement report to its serving RAN. The serving RAN compares the measured signal strengths to a handover threshold and directs the user device to handover when the threshold is triggered. Different RANs utilize different Radio Access Technologies (RATs) like 5GNR and LTE. The wireless user devices use different techniques to measure received signal strength for the different RATs. Unfortunately, the different measuring techniques reduce the accuracy at which the RANs can directly compare received signal strengths for different RATs. The reduced accuracy causes the RANs to handover wireless user devices when handover conditions are not actually met.

Unfortunately, wireless communication networks do not effectively compare received signal strengths for different RAT types. Moreover, the wireless communication networks do not efficiently perform inter-RAT handover of wireless user devices.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions to handover wireless User Equipment (UE). Some embodiments comprise a method of operating a wireless access node to steer a wireless user device to a Radio Access Technology (RAT) type. The method comprises wirelessly receiving a measurement report from a wireless user device that comprises a first measured signal strength for a first RAT type and a second measured signal strength for a second RAT type wherein the sampling rate for the first measured signal strength is different than the sampling rate for the second measured signal strength. The method further comprises applying a calibration factor to the second measured signal strength to normalize the second measured signal strength with the first measured signal strength. The method further comprises comparing the normalized second measured signal strength to the first measured signal strength. The method further comprises wirelessly transferring an attachement instruction to the wireless user device to attach to the first RAT type or the second RAT type based on the comparison.

Some embodiments comprise a wireless access node configured to steer a wireless user device to a RAT type. The wireless access node comprises radio circuitry and node circuitry. The radio circuitry receives a measurement report from a wireless user device that comprises a first measured signal strength for a first RAT type and a second measured signal strength for a second RAT type wherein the sampling rate for the first measured signal strength is different than the sampling rate for the second measured signal strength. The node circuitry applies a calibration factor to the second measured signal strength to normalize the second measured signal strength with the first measured signal strength. The node circuitry compares the normalized second measured signal strength to the first measured signal strength. The radio circuitry wirelessly transfers an attachement instruction to the wireless user device to attach to the first RAT type or the second RAT type based on the comparison.

Some embodiments comprise one or more non-transitory computer-readable storage media having program instructions stored thereon to steer a wireless user device to a RAT type. The program instructions, when executed by a computing system, direct the computing system to perform operations. The operations comprise receiving a measurement report from a wireless user device that comprises a first measured signal strength for a first RAT type and a second measured signal strength for a second RAT type wherein the sampling rate for the first measured signal strength is different the second sampling rate for the second measured signal strength. The operations further comprise applying a calibration factor to the second measured signal strength to normalize the second measured signal strength with the first measured signal strength. The operations further comprise comparing the normalized second measured signal strength to the first measured signal strength. The operations further comprise transferring an attachement instruction to the wireless user device to attach to the first RAT type or the second RAT type based on the comparison.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless communication network to steer a wireless user device to a Radio Access Technology (RAT) type using a calibrated measurement report.

FIG. 2 illustrates an exemplary operation of the wireless communication network to steer the wireless user device to a RAT type using the calibrated measurement report.

FIG. 3 illustrates a wireless communication network to steer a UE to a RAT type using a calibrated Fifth Generation New Radio (5GNR) measurement report.

FIG. 4 illustrates an exemplary operation of the wireless communication network to steer the UE to a RAT type using the calibrated 5GNR measurement report.

FIG. 5 illustrates the wireless communication network to steer the UE to a RAT type using the calibrated 5GNR measurement report.

FIG. 6 illustrates a Fifth Generation (5G) wireless communication network to steer a 5G/Long Term Evolution (LTE) UE using a calibrated 5GNR measurement report.

FIG. 7 illustrates the 5G/LTE UE in the 5G communication network.

FIG. 8 illustrates a 5G Radio Access Network (RAN) in the 5G wireless communication network.

FIG. 9 illustrates an LTE RAN in the 5G wireless communication network.

FIG. 10 illustrates a Network Function Virtualization Infrastructure (NFVI) in the 5G wireless communication network.

FIG. 11 illustrates an exemplary operation of the 5G wireless communication network to steer the 5G/LTE UE using the calibrated 5GNR measurement report.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

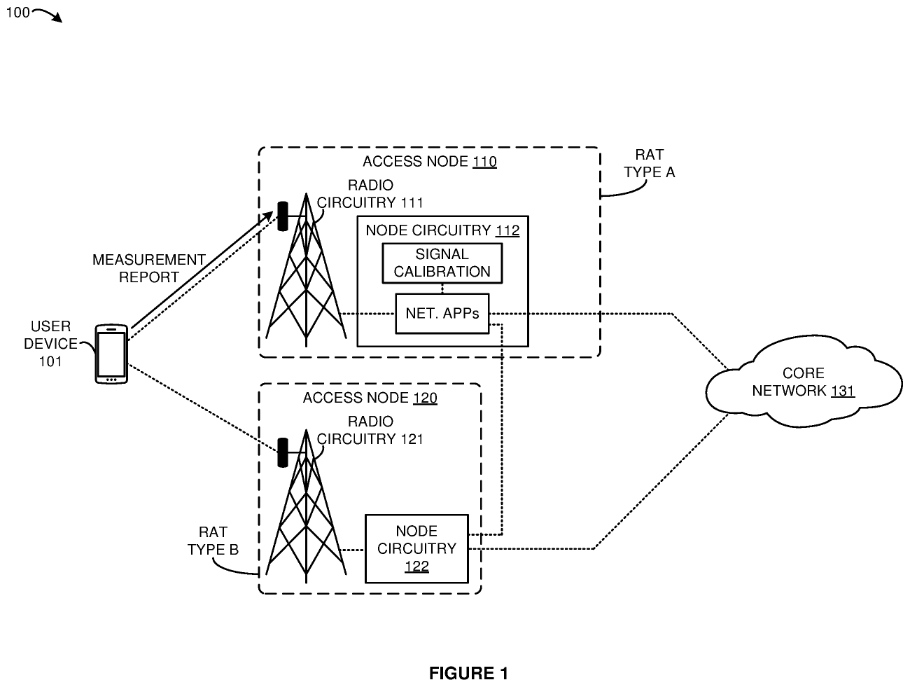

FIG. 1 illustrates wireless communication network 100 to steer a wireless user device to a Radio Access Technology (RAT) type using a calibrated measurement report. Wireless communication network 100 delivers services like voice calling, internet-access, media-streaming, machine communications, or some other wireless communications product to user devices. Wireless communication network 100 comprises user device 101, access node 110, access node 120, and core network 131. Access node 110 comprises radio circuitry 111 and node circuitry 112. Node circuitry 112 hosts network applications (NET. APPs.) and an application for inter-RAT signal strength calibration (SIGNAL CALIBRATION). Access node 120 comprises radio circuitry 121 and node circuitry 122. Access nodes 110 and 120 are different RAT types. Access node 110 is a RAT type A node while access node 120 is a RAT type B node. In other examples, wireless network communication network 100 may comprise additional or different elements than those illustrated in FIG. 1.

Various examples of network operation and configuration are described herein. In some examples, radio circuitry 111 wirelessly receives a measurement report from user device 101. The measurement report characterizes signal strengths measured by user device 101 for access node 110 and access node 120. Since access node 110 and access node 120 comprise different RAT types, the sampling rate used by user device 101 to measure the signal strength for access node 110 and access node 120 are different. Radio circuitry 111 transfers the measurement report to node circuitry 112. Node circuitry 112 executes the network applications to process the measurement report. The network applications apply a calibration factor to one of the signal strengths measured by user device 101 to normalize the first signal strength (e.g., RAT type A signal strength) with the second signal strength (e.g., RAT type B signal strength) to account for the difference in sampling rates. The network applications compare the normalized (i.e., calibrated) signal strength with the unmodified signal strength. The network applications generate an attachement command for user device 101 to attach to either access node 110 or access node 120 based on the comparison. The network applications transfer the attachement command to radio circuitry 111. Radio circuitry wirelessly transfers the attachment command to user device 101. Typically, the attachement command directs user device 101 to attach to an access node when the measured signal strength triggers a threshold. Exemplary inter-RAT attachement thresholds include B1 and B2 thresholds.

Wireless communication network 100 provides wireless data services to user device 101. Exemplary user devices include phones, wearables, computers, vehicles, robots, and sensors. Access nodes 110 and 120 exchanges wireless signals with user device 101 over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access nodes 110 and 120 are connected to core network 131 over backhaul data links. Access nodes 110 and 120 exchange network signaling and user data with network elements in core network 131. Access nodes 110 and 120 may comprise wireless access points, Radio Access Networks (RANs), edge computing systems, or other types of wireless/wireline access systems to provide the wireless/wireline links, backhaul data links, and/or edge computing services between user device 101 and core network 131.

Access nodes 110 and 120 may comprise a Fifth Generation (5G) RANs, LTE RANS, gNodeBs, eNodeBs, NB-IoT access nodes, LP-WAN base stations, wireless relays, WIFI hotspots, Bluetooth access nodes, and/or another type of wireless network transceiver. Access nodes 110 and 120 may comprise Radio Units (RUs), Distributed Units (DUs) and Centralized Units (CUs). Access nodes 110 and 120 may comprise Baseband Units (BBUs). For example, radio circuitry 111 may comprise an RU and node circuitry 112 may comprise a DU and a CU. For example, radio circuitry 121 may comprise an RU and node circuitry 122 may comprise a BBU. The RUs may be mounted at elevation and have antennas, modulators, signal processors, and the like. The RUs are connected to the DUs or BBUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 131. The CUs handle higher wireless network layers like the Radio Resource Control (RRC), Service Data Adaption Protocol (SDAP), and Packet Data Convergence Protocol (PDCP). The CUs are coupled to network functions in core network 131. The BBUs hand wireless network layers like RRC, PDCP, RLC, MAC, and PHY. The BBUs are coupled to network functions in core network 131.

Core network 131 is representative of computing systems that provide wireless data services to user device 101 over access nodes 110 and 120. Exemplary computing systems comprise data centers, edge computing networks, cloud computing networks, application servers, and the like. The computing systems of core network 131 store and execute the network functions to provide wireless data services to user device 101 over access nodes 110 and 120. Exemplary network functions include Access and Mobility Management Function (AMF), Session Management Function (SMF), User Plane Function (UPF), Mobility Management Entity (MME), Serving Gateway (SGW) and Packet Data Network Gateway (PGW). Core network 131 may comprise a Fifth Generation Core (5GC) architecture and/or an Evolved Packet Core (EPC) architecture.

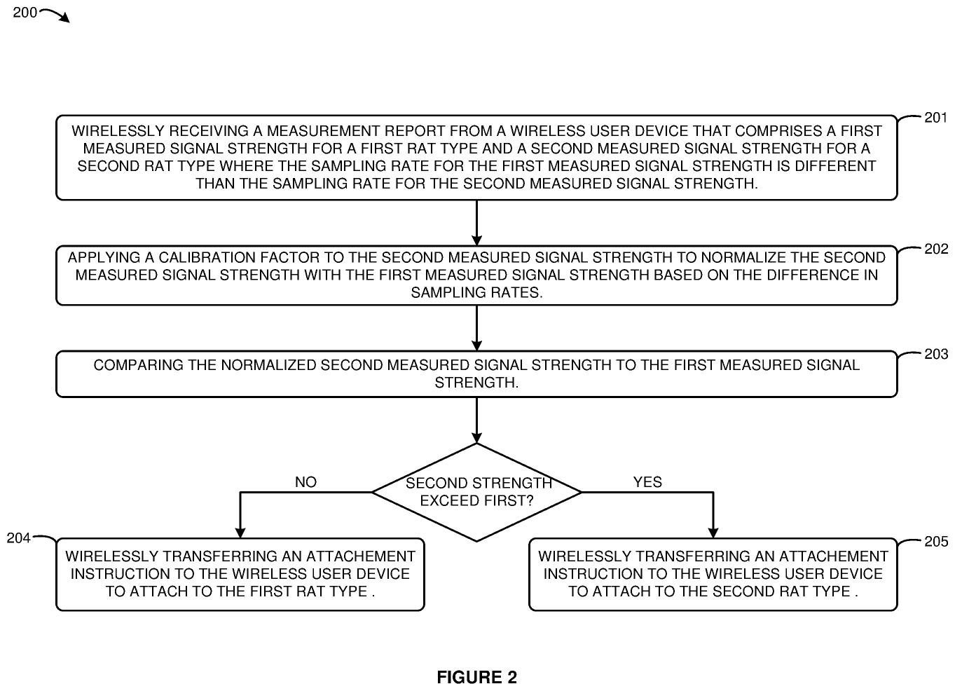

FIG. 2 illustrates process 200. Process 200 comprises an exemplary operation of wireless communication network 100 to steer a wireless user device to a RAT type using a calibrated measurement report. The operation may vary in other examples. The operations of process 200 comprise wirelessly receiving a measurement report from a wireless user device that comprises a first measured signal strength for a first RAT type and a second measured signal strength for a second RAT type where the sampling rate for the first measured signal strength is different than the sampling rate for the second measured signal strength (step 201). The operations further comprise applying a calibration factor to the second measured signal strength to normalize the second measured signal strength with the first measured signal strength based on the difference in sampling rates (step 202). The operations further comprise comparing the normalized second measured signal strength to the first measured signal strength (step 203). If the signal strength for the first RAT type exceeds the normalized signal strength for the second RAT type, the operations proceed by wirelessly transferring an attachement instruction to the wireless user device to attach to the first RAT type (step 204). If the normalized signal strength for the second RAT type exceeds the signal strength for the first RAT type, the operations proceed by wirelessly transferring an attachement instruction to the wireless user device to attach to the second RAT type (step 205).

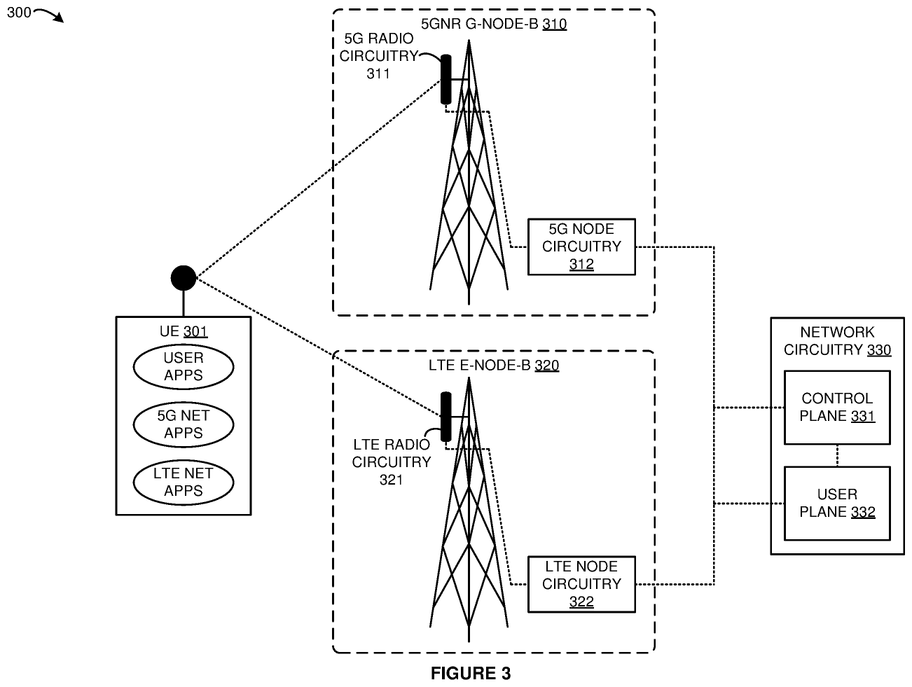

FIG. 3 illustrates wireless communication network 300 network to steer a User Equipment (UE) to a RAT type using a calibrated 5GNR signal measurement. Wireless communication network 300 is an example of wireless network 100, however network 100 may differ. Wireless communication network 300 comprises UE 301, 5GNR gNodeB 310, LTE eNodeB 320, and network circuitry 330. UE 301 comprises user applications (USER APPS), Fifth Generation (5G) network applications (5G NET APPS), and Long Term Evolution (LTE) network applications (LTE NET APPS). 5GNR gNodeB 310 comprises 5G radio circuitry 311 and 5G node circuitry 312. LTE eNodeB 320 comprises LTE radio circuitry 321 and LTE node circuitry 322. Network circuitry 330 comprises control plane 331 and user plane 332. In other examples, wireless network 300 may comprise additional or different elements than those illustrated in FIG. 3.

In some examples, UE 301 attaches to LTE node circuitry 322 over LTE radio circuitry 322. UE 301 measures the reference signal strength for 5GNR gNodeB 310 and LTE eNodeB 320 to determine if/when to handover from eNodeB 320 to gNodeB 310. Since nodes 310 and 320 are different RAT types, UE 310 samples the reference signals for gNodeB 310 and eNodeB 320 at different rates. Typically, UE 310 samples the reference signal from eNodeB 320 at a higher rate than the reference signal from gNodeB 310. Exemplary signal measurements include Reference Signal Received Power (RSRP) and Reference Signal received Quality (RSRQ). The LTE network applications in UE 301 generate a measurement report that comprises the measured signal strength for gNodeB 310 and eNodeB 320. UE 301 wirelessly transfers the measurement report to LTE radio circuitry 321. LTE radio circuitry 321 forwards the measurement report to LTE node circuitry 322. LTE node circuitry 322 applies a calibration factor to normalize the measured signal strength for gNodeB 310 with the measured signal strength for eNodeB 320. LTE node circuitry 322 may multiply the received 5GNR signal strength by the calibration factor to account for the difference in sampling rates. In particular, LTE node circuitry 322 estimates a 5GNR signal strength for UE 301 if the 5GNR signal measured by UE 301 had been measured using the same sampling rate as the measured LTE signal strength. By accounting for the difference in sampling rates, access nodes can directly compare received signal strengths for different RAT types more accurately. Once the 5GNR signal strength is normalized, LTE node circuitry 322 compares the LTE signal strength and the normalized 5GNR signal strength to a handover threshold. If the LTE signal strength falls below the threshold and/or the normalized 5GNR signal strength exceeds the threshold, LTE node circuitry 322 generates and transfers a handover command for delivery to UE 301.

Advantageously, wireless communication network 300 effectively compares received signal strengths for different RAT types by normalizing the received signal strengths based on the difference in sampling rates. Moreover, the wireless communication network 300 efficiently performs inter-RAT handover of UE 301 using the normalized signal strengths.

UE 301, 5GNR gNodeB 310, and LTE eNodeB 320 communicate over links using wireless technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. 5GNR gNodeB 310, LTE eNodeB 320, and network circuitry 330 communicate over various links that use metallic links, glass fibers, radio channels, or some other communication media. The links use Fifth Generation Core (5GC), Evolved Packet Core (EPC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 may comprise a phone, vehicle, computer, sensor, drone, robot, or another type of data appliance with wireless and/or wireline communication circuitry. Although nodes 310 and 320 are illustrated as towers, nodes 310 and 320 may comprise other types of mounting structures (e.g., buildings), or no mounting structures at all. UE 301, gNodeB 310, and eNodeB 320 comprise antennas, amplifiers, filters, modulation, analog/digital interfaces, microprocessors, software, memories, transceivers, bus circuitry, and the like. Control plane 321 comprises network functions and network elements like MME, AMF, SMF, and the like. User plane 322 comprises network functions and network elements like UPF, SGW, PGW, and the like.

UE 301, nodes 310 and 320, and network circuitry 330 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, radio applications, network functions, and multimedia functions. The microprocessors retrieve the software from the memories and execute the software to drive the operation of wireless communication network 300 as described herein.

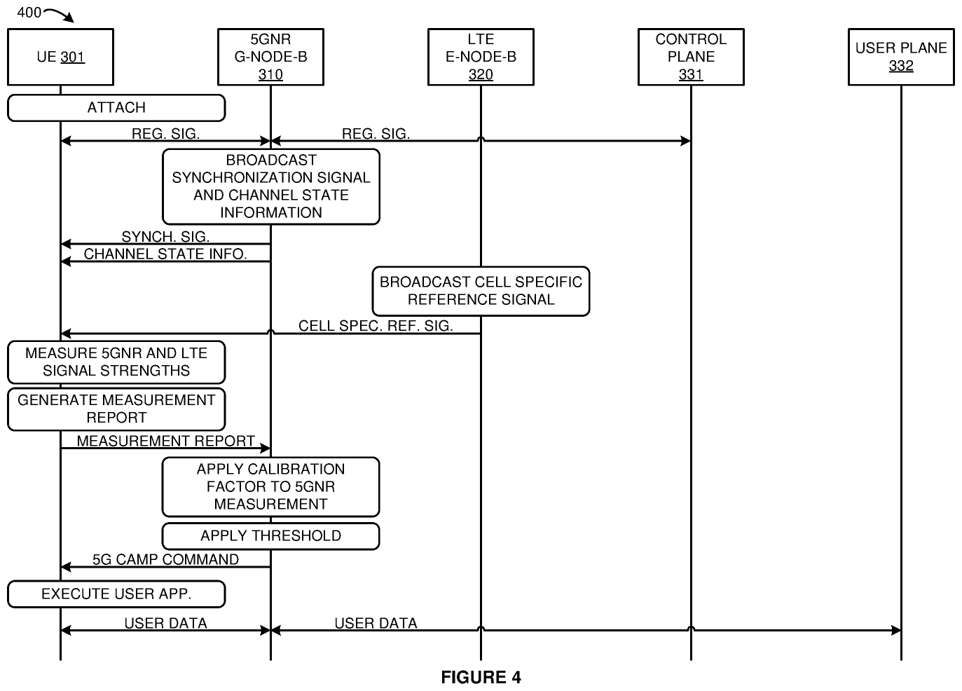

FIG. 4 illustrates process 400. Process 400 comprises an exemplary operation of wireless communication network 300 to steer a UE to a RAT type using a calibrated 5GNR signal measurement. The operation may vary in other examples. In operation, UE 301 wirelessly attaches to 5GNR gNodeB 310. UE 301 exchanges registration signaling with control plane 331 over gNodeB 310 to receive wireless data services. Once registered, UE 301 may receive wireless data services from network circuitry 330 over gNodeB 310.

5GNR gNodeB 310 periodically broadcasts Synchronization Signal (SS) resource blocks and Channel State Information (CSI) resource blocks to UE 301. For example, gNodeB 310 may broadcast a CSI resource block every 20 ms. Concurrently, LTE eNodeB 320 continuously broadcasts Cell Specific Reference Signal (CRS) resource blocks to UE 301. For example, eNodeB 320 may broadcast CRS resource blocks every 1 ms. The CSI, SS, and CRS resource blocks are types of reference signals which UE 301 can measure to determine received signal strength for nodes 310 and 320. It should be appreciated that the rate at which 5GNR gNodeB 310 and LTE eNodeB 320 broadcast their reference signals is different. UE 301 wirelessly receives the 5GNR SS and CSI resource blocks from gNodeB 310 and the CRS resource blocks from eNodeB 320. UE 301 synchronizes with 5GNR gNodeB 310 using the SS resource blocks and measures 5GNR signal strength for gNodeB 310 using the CSI blocks. UE 301 measures LTE signal strength for eNodeB 320 based on the CRS resource blocks. For example, UE 301 may determine a 5GNR RSRP for 5GNR gNodeB 310 based on the CSI resource blocks and determine an LTE RSRP for LTE eNodeB 320 based on the CRS resource blocks. UE 301 generates and wirelessly transfers a measurement report that includes the 5GNR and LTE signal strengths to 5GNR gNodeB 310.

5GNR gNodeB 310 receives the measurement report wirelessly transferred by UE 301. 5GNR gNodeB 310 applies a calibration factor to the 5GNR signal strength to generate a normalized 5GNR signal strength. For example, gNodeB 310 may host a data structure that correlates measured 5GNR signal strengths to normalized 5GNR signal strengths based on the difference in sampling rates for the LTE reference signals and 5GNR reference signals. Once normalized, 5GNR gNodeB 310 applies a handover threshold to the measured LTE signal strength and the normalized 5GNR signal strength. In this example, the handover threshold is not triggered and 5GNR gNodeB 310 transfers a camping command for UE 301 to remain on gNodeB 310. Subsequently, UE 301 executes a user application and exchanges user data with user plane 332 over gNodeB 310. In other examples, the measured signal strengths may trigger thresholds for handover and/or dual connectivity. For example, if the LTE signal strength exceeds a threshold value and the normalized 5GNR signal strength falls below another threshold value, 5GNR gNodeB 310 may transfer a handover command to UE 301 to handover to LTE eNodeB 320. For example, if the LTE signal strength exceeds a threshold value and the normalized 5GNR signal strength exceeds another threshold value, 5GNR gNodeB 310 may transfer a dual connectivity command to UE 301 to attach to both LTE eNodeB 320 and 5GNR gNodeB 310.

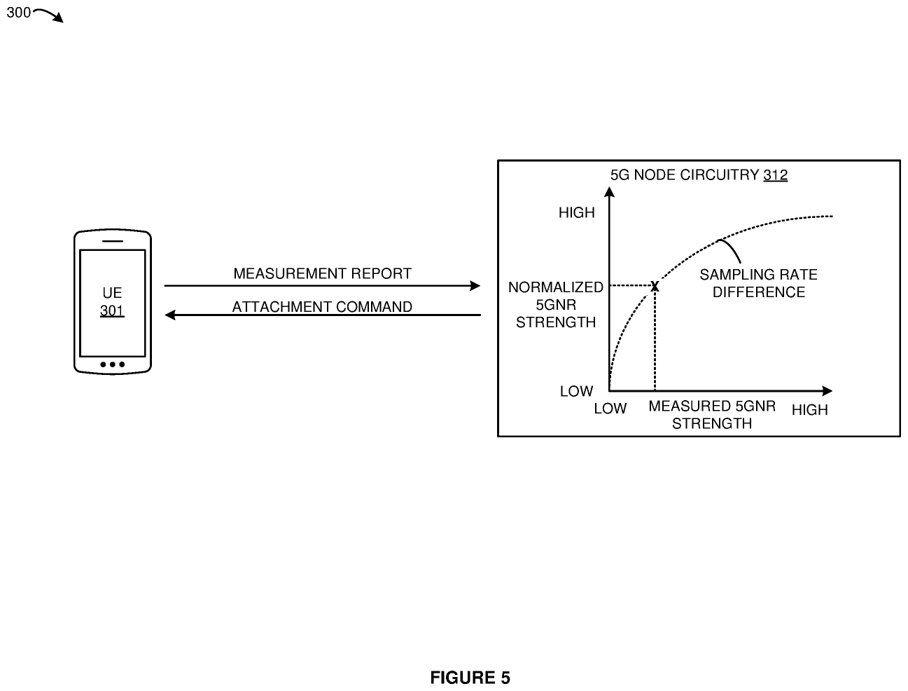

FIG. 5 further illustrates UE 301 and 5GNR node circuitry 312 in wireless communication network 300. UE 301 wirelessly transfers a measurement report for delivery to node circuitry 312 that includes a measured 5GNR signal strength for gNodeB 310 and a measured LTE signal strength for eNodeB 320. The measurement report may comprise a B1 measurement report, B2 measurement report, and/or another type of inter-RAT measurement report. 5G node circuitry 312 hosts a data structure that implements the graph illustrated in FIG. 5. The x-axis of the graph represents measured 5GNR signal strength received from UE 301 in an exemplary range Low to High. The y-axis of the graph represents normalized 5GNR signal strength in an exemplary range Low to High. The curve on the graph labeled sampling rate difference represents an inter-RAT sampling rate difference between the measured 5GNR signal strength and the measured LTE signal strength. As illustrated on FIG. 3, a measured 5GNR signal strength correlates to a normalized 5GNR signal strength based on the sampling rate difference curve. The sampling rate difference curve may be generated empirically or may be modeled. Generally, when the sampling rate difference between the 5GNR signal strength and the other RAT type is low, the difference between the measured 5GNR strength and the normalized signal strength is also low. Conversely, when the sampling rate difference between the 5GNR signal strength and the other RAT type is high, the difference between the measured 5GNR strength and the normalized signal strength is also high. It should be appreciated that the sampling rate curve is exemplary and may differ in other examples.

5GNR node circuitry 312 generates and transfers an attachement command based on the normalized 5GNR signal strength for delivery to UE 301. For example, 5GNR node circuitry 312 applies the normalized 5GNR signal strength and measured LTE signal strength to one or more inter-RAT handover/dual connectivity thresholds like B1 thresholds or B2 thresholds to generate the attachement command. UE 301 wirelessly receives the attachement command and responsively performs the commanded attachement procedure. For example, the attachement command may direct UE 301 to camp on gNodeB 310, handover to LTE eNodeB 320, or establish dual connectivity with eNodeB 320 and gNodeB 310.

When UE 301 measures signal strength for LTE eNodeB 320 and 5GNR gNodeB 310, the number of signal strength measurements (e.g., samples) for eNodeB 320 typically exceeds the number of signal strength measurements for gNodeB 310. This difference is caused by eNodeB 320 broadcasting reference signal resource blocks at higher rate than gNodeB 310. The difference in sampling sizes limits the accuracy at which node circuitry 312 can directly compare the raw signal strength measurements received from UE 301. By implementing the graph illustrated in FIG. 5 and normalizing the 5GNR signal strength based on the sampling size difference, node circuitry 312 improves the accuracy of inter-RAT signal strength comparisons.

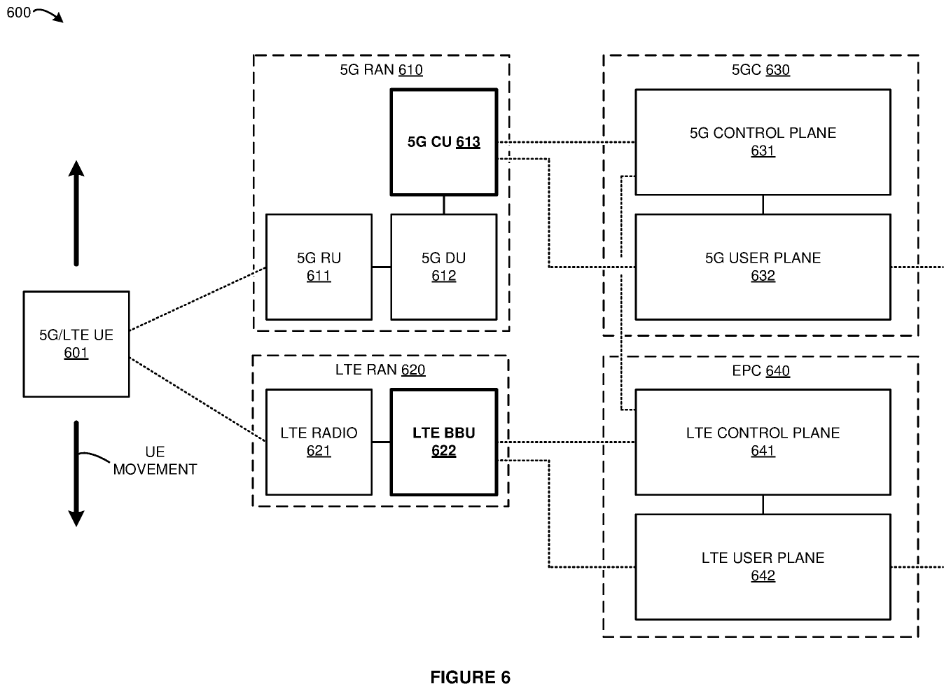

FIG. 6 illustrates 5G communication network 600 to steer a wireless UE using a calibrated 5GNR measurement report. 5G communication network 600 comprises an example of wireless communication networks 100 and 300, although networks 100 and 300 may differ. 5G communication network 600 comprises 5G/LTE UE 601, 5G RAN 610, LTE RAN 620, Fifth Generation Core (5GC) 630, and Evolved Packet Core (EPC) 640. 5G RAN 610 comprises 5G Radio Unit (RU) 611, 5G Distribute Unit (DU) 612, and 5G Centralized Unit (CU) 613. LTE RAN 620 comprises LTE radio 621 and LTE Baseband Unit (BBU) 622. 5GC 630 comprise 5G control plane 631 and 5G user plane 632. EPC 640 comprises LTE control plane 641 and LTE user plane 642. 5G control plane 631 comprises 5GC network functions and network entities like Access and Mobility Management Function (AMF), Session Management Function (SMF), Authentication Server Function (AUSF), Network Slice Selection Function (NSSF), Policy Control Function (PCF), Network Repository Function (NRF), Network Exposure Function (NEF), Application Function (AF), and Unified Data Management (UDM). 5G user plane 632 comprises 5GC network functions and network entities like User Plane Function (UPF). LTE control plane 641 comprises EPC network functions and network entities like Mobility Management Entity (MME), Access Network Discovery and Selection Function (ANDSF), Policy and Charging Rules Function (PCRF), and Home Subscriber Server (HSS). LTE user plane 642 comprises EPC network functions and network entities like Serving Gateway (SGW) and Packet Data Network Gateway (PGW). In other examples, wireless network communication network 600 may comprise additional or different elements than those illustrated in FIG. 6.

UE 601 wirelessly attaches to CU 613 via DU 612 and RU 611. UE 601 exchanges attachment signaling with CU 613 to establish a connection with 5G network applications hosted by CU 613. UE 601 transfers a registration request that indicates a registration type, UE capabilities, requested slice types, and Protocol Data Unit (PDU) session requests to 5G control plane 631 over RAN 610. The 5GC network functions that comprise 5G control plane 631 interact to authenticate and authorize UE 601 for wireless data service. Responsive to the authentication and authorization, 5G control plane 631 generates UE context to establish the wireless data service. The UE context comprises metrics like Quality-of-Service (QOS), slice Identifiers (IDs), service attributes, network addresses, and the like. Control plane 631 transfers the UE context to UE 601 over 5G RAN 610. UE 601 receives the UE context and uses the network addresses to begin a PDU session. UE 601 exchanges user data with 5G user plane 632 over RAN 610. 5G control plane 632 exchanges the user data with external systems like data networks and application servers.

As UE 601 moves around, the received signal strength from RANs 610 and 620 varies. The variance in received signal strength may force UE to handover from 5G RAN 610 to LTE RAN 620 or allow UE 601 to establish 5G/LTE dual connectivity. 5G DU 612 generates Channel State Information (CSI) resource blocks and Synchronization Signal (SS) resource blocks. 5G RAN 610 broadcasts the CSI resource blocks and SS resource blocks over RU 611. Concurrently, LTE BBU 612 generates Cell Specific Reference Signal (CRS) resource blocks. LTE RAN 620 broadcasts the CRS resource blocks over LTE radio 621. The rate at which CSI and SS resource blocks are broadcast and the rate at which CRS are broadcast are different. For example, 5G RAN 610 may broadcast CSI blocks every 20 ms while LTE RAN 620 may broadcast CRS blocks continuously.

UE 601 wirelessly receives the CSI and SS resource blocks from 5G RAN 610 and wirelessly receives the CRS resource blocks from LTE RAN 620. UE 601 synchronizes with 5G RAN 610 using the SS resource blocks and measures the RSRP of the CSI blocks to determine the received signal strength of 5G RAN 610. UE 601 measures the RSRP of the CRS resource blocks to determine the received signal strength of LTE RAN 620. Since the CSI blocks are broadcast at a different rate than the CRS resource blocks, the sampling rates used by UE 601 to measure the received signal strengths for RANs 610 and 620 are correspondingly different. Typically, UE 601 samples (i.e., measures) the LTE CRS blocks more frequently than the 5G CSI blocks. UE 601 generates a measurement report that comprises the measured RSRP for 5G RAN 610 and the measured RSRP for LTE RAN 620. UE 601 includes the sampling rate used to determine the RSRPs in the measurement report. UE 601 wirelessly transfers the measurement report to CU 613 over RU 611 and DU 612.

CU 613 reads the measurement report to determine the 5G RSRP for RAN 610, the 5G sampling rate for the 5G RSRP, the LTE RSRP for RAN 620, and the LTE sampling rate for the LTE RSRP. CU 613 identifies a sampling rate difference between the 5G sampling rate and the LTE sampling rate. CU 613 maintains a table of calibration factors to adjust 5GNR RSRPs to account for inter-RAT sampling rate differences. Each calibration factor is associated with a sampling rate difference. The sampling rate difference may comprise a numeric value or a range of numeric values. The calibration factors may be determined empirically or by modeling. For example, a network operator may measure 5GNR signal strengths at various sampling rates to empirically determine the calibration factors. CU 613 selects one of the calibration factors based on the sampling rate difference and applies the selected factor to the 5GNR RSRP to generate a normalized 5GNR RSRP. For example, CU 613 may multiply the measured 5GNR RSRP by the selected calibration factor to generate the normalized RSRP. The normalized 5GNR RSRP comprises an estimate of the measured 5GNR RSRP had the measured 5GNR RSRP by generated using the same sampling rate as the LTE RSRP.

CU 613 compares the normalized 5GNR RSRP and the LTE RSRP to a B2 handover threshold and compares the normalized LTE RSRP to a B1 dual connectivity threshold. The B1 threshold and B2 threshold are defined as:

$${M}_{n} + O - Hys > TH \qquad B1 Threshold$$

$${M}_{p} + Hys < {TH}_{1} \& {M}_{n} + O - Hys > {TH}_{2} \qquad B2 Threshold$$

For the B1 threshold, Mₙ is the neighbor cell signal strength, O is the frequency offset, Hys is the hysteresis value, and TH is the threshold value. For the B2 threshold, Mₚ is the serving cell signal strength, Mₙ is the neighbor cell signal strength, O is the frequency offset, Hys is the hysteresis value, TH₁ is the serving threshold value, and TH₂ is the neighbor threshold value. The offset parameters can be understood as the frequency difference between the serving and neighbor cells. The hysteresis parameter can be understood as a buffer value to inhibit ping pong behavior (i.e., repetitive handover) by the UE.

CU 613 sums the LTE RSRP, offset value for LTE RAN, and hysteresis and compares this value to the B1 threshold value. When the sum exceeds the B1 threshold value, CU 613 generates an addition command for UE 601 to add LTE RAN 620 for dual connectivity. When the sum does not exceed the B1 threshold value, CU 613 does not generate the addition command for UE 601.

CU 613 sums the normalized 5GNR RSRP and hysteresis value and compares this sum to the first B2 threshold value. CU 613 sums the LTE RSRP, the offset, and the hysteresis value and compares this sum to the second B2 threshold value. When the first B2 sum does not exceed the first B2 threshold and when the second B2 sum exceeds the second B2 threshold value, CU 613 generates a handover command for UE 601 to handover to LTE RAN 620. When the first B2 sum exceeds the first B2 threshold and/or the second B2 sum does not exceed the second B2 threshold value, CU 613 does not generate a handover command for UE 601.

In the example where the B1 threshold is triggered, CU 613 transfers the addition command to UE 601 over DU 612 and RU 611. CU 613 notifies 5G control plane 631 of the addition. 5G control plane 631 interfaces with LTE control plane 641 to add LTE RAN 620. LTE control plane 641 directs LTE BBU 622 to serve UE 601. Concurrent to the control plane signaling, UE 601 receives the addition command and responsively exchanges attachment signaling with LTE BBU 622 over LTE radio 621. BBU 622 interfaces with LTE control plane 641 to authenticate and authorize UE 601 on EPC 640. Responsive to authentication and authorization, LTE control plane 641 transfers the UE context to UE 601 over LTE RAN 620. UE 601 utilizes UE context to begin a PDU session over EPC 640. UE 601 exchanges user data with LTE user plane 642 over RAN 620. LTE control plane 642 exchanges the user data with external systems like data networks and application servers.

In the example where the B2 threshold is triggered, CU 613 transfers the handover command to UE 601 over DU 612 and RU 611. CU 613 notifies 5G control plane 631 of the handover requirement. 5G control plane 631 interfaces with LTE control plane 641 to handover UE 601 to LTE RAN 620. LTE control plane 641 directs LTE BBU 622 to serve UE 601. Concurrent to the control plane signaling, UE 601 receives the handover command and detaches from 5GNR RAN 610. UE 601 exchanges attachment signaling with LTE BBU 622 over LTE radio 621. BBU 622 interfaces with LTE control plane 641 to authenticate and authorize UE 601 on EPC 640. Responsive to authentication and authorization, LTE control plane 641 transfers UE context to UE 601 over LTE RAN 620. UE 601 utilizes the UE context to begin a wireless data session over EPC 640. UE 601 exchanges user data with LTE user plane 642 over RAN 620. LTE control plane 642 exchanges the user data with external systems like data networks and application servers. In some examples, 5G RAN 610 may possess a direct connection (e.g., an X2 link) with LTE RAN 620. In such examples, 5G RAN 610 and LTE RAN 620 may exchange handover/addition signaling directly instead of exchanging this signaling over control planes 631 and 641.

Although the above examples are presented in the context where UE 601 initially attaches to 5G RAN 610, these examples also apply to situations where UE 601 initially attaches to LTE RAN 620. Similar to CU 613, BBU 622 also maintains a table of calibration factors to adjust 5GNR RSRPs to account for inter-RAT sampling rate differences. BBU 622 uses the calibration factors to normalize 5GNR RSRPs in a manner similar to CU 613. BBU 622 applies the 5GNR RSRPs to B1 and B2 thresholds to control handover to 5G RAN 610 and addition of 5G RAN 620. Moreover, although the above examples are given in the context of RSRP, CU 613 and BBU 622 may normalize other types of signal strength/quality metrics like Received Signal Strength Indication (RSSI), Reference Signal Received Quality (RSRQ), and the like. These additional metrics may be used in place of or in addition to RSRP when handing over or establishing dual connectivity.

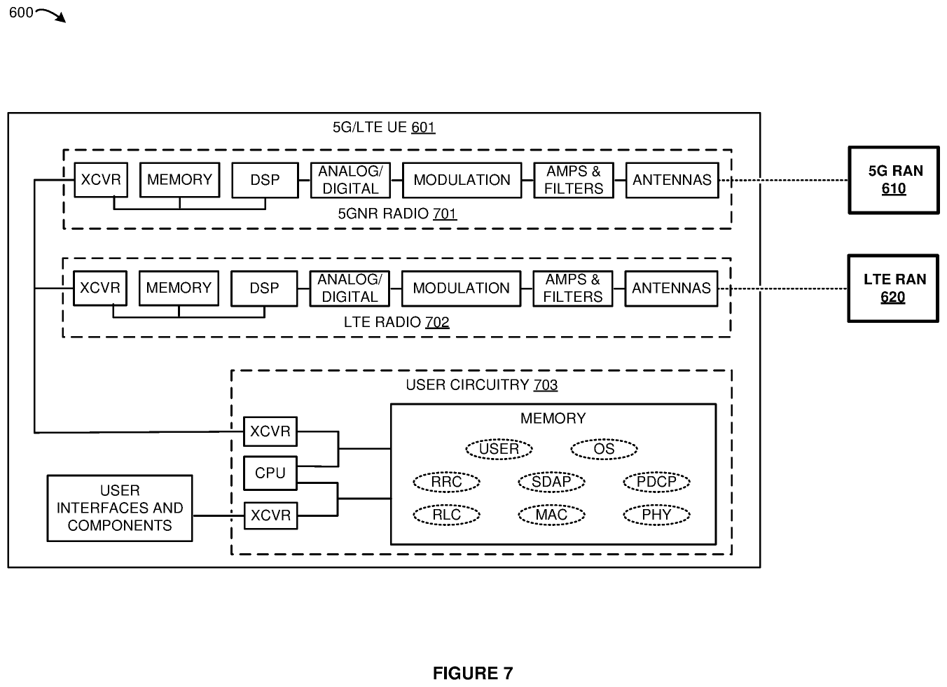

FIG. 7 illustrates 5G UE 601 in 5G communication network 600. UE 601 comprises an example of user device 101 illustrated in FIG. 1 and UE 301 illustrated in FIG. 3, however user device 101 and UE 301 may differ.

UE 601 comprises 5G radio 701, LTE radio 702, and user circuitry 703. 5GNR Radio 701 comprises antennas, amplifiers, filters, modulation, analog-to-digital interfaces, Digital Signal Processers (DSP), memory, and transceivers (XCVRs) that are coupled over bus circuitry. LTE Radio 702 comprises antennas, amplifiers, filters, modulation, analog-to-digital interfaces, Digital Signal Processers (DSP), memory, and transceivers (XCVRs) that are coupled over bus circuitry. User circuitry 703 comprises memory, CPU, user interfaces and components, and transceivers that are coupled over bus circuitry. The memory in user circuitry 703 stores an operating system (OS), user applications (USER), 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC), and LTE network applications for PHY, MAC, RLC, and PDCP. The corresponding LTE and 5GNR network applications (e.g., 5GNR PHY and LTE PHY) have been combined in FIG. 7 for sake of clarity. The antenna in radio 701 is wirelessly coupled to 5G RAN 610 over a 5GNR link. The antenna in LTE radio 702 is wirelessly coupled to LTE RAN 620 over an LTE link. Transceivers in radios 701 and 702 are coupled to a transceiver in user circuitry 703. A transceiver in user circuitry 703 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 703 over the transceivers. In user circuitry 703, the CPU executes the 5GNR network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

In radio 702, the antennas receive wireless signals from LTE RAN 620 that transport downlink LTE signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding LTE symbols to user circuitry 703 over the transceivers. In user circuitry 703, the CPU executes the LTE network applications to process the LTE symbols and recover the downlink LTE signaling and data. The LTE network applications receive new uplink signaling and data from the user applications. The network applications process the uplink user signaling and the downlink LTE signaling to generate new downlink user signaling and new uplink LTE signaling. The network applications transfer the new downlink user signaling and data to the user applications. The LTE network applications process the new uplink LTE signaling and user data to generate corresponding uplink LTE symbols that carry the uplink LTE signaling and data.

In radio 702, the DSP processes the uplink LTE symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless LTE signals to LTE RAN 620 that transport the uplink LTE signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

In some examples, the RRC in UE 601 generates measurement reports characterizing the RSRP for 5G RAN 610 and LTE RAN 620. The RRC controls the lower layer 5GNR network applications like 5GNR PHY to measure 5GNR RSRP for CSI resource blocks received from 5G RAN 610. The RRC controls the lower layer LTE network applications like LTE PHY to measure LTE RSRP for CRS resource blocks received from LTE RAN 620. The RRC tracks the sampling rate used to generate the 5GNR RSRP and the sampling rate used to generate the LTE RSRP. The RRC generates a measurement report comprising the 5GNR RSRP, the 5GNR sampling rate, the LTE RSRP, and the LTE sampling rate. The RRC controls the lower layer network functions to transfer the measurement report to 5G RAN 610 and/or LTE RAN 620 depending on the connection status of UE 601.

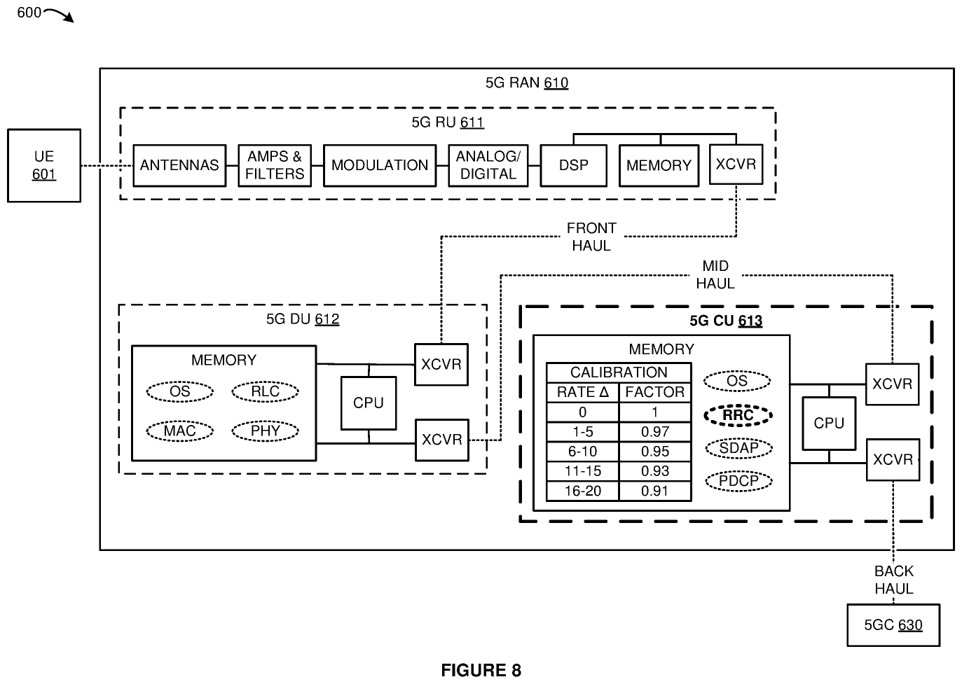

FIG. 8 illustrates 5G RU 611, 5G DU 612, and 5G CU 613 in 5G communication network 600. RU 611, DU 612, and CU 613 comprise an example of access nodes 110 and 120 illustrated in FIG. 1 and 5GNR gNodeB 310 illustrated in FIG. 3, however access nodes 110, 120, and gNodeB 310 may differ.

RU 611 comprises antennas, amplifiers, filters, modulation, analog-to-digital interfaces, DSP, memory, and transceivers (XCVRs) that are coupled over bus circuitry. UE 601 is wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UE 601 and to exchange 5GNR data with DU 612.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 612 comprises memory, CPU, and transceivers that are coupled over bus circuitry. The memory in 5G DU 612 stores operating systems and 5GNR network applications like PHY, MAC, and RLC. CU 613 comprises memory, CPU, and transceivers that are coupled over bus circuitry. The memory in CU 613 stores an operating system, 5GNR network applications like PDCP, SDAP, and RRC, and a calibration table to normalize 5GNR measurements for inter-RAT signal strength comparisons. Transceivers in 5G DU 612 are coupled to transceivers in RU 611 over front-haul links. Transceivers in DU 612 are coupled to transceivers in CU 613 over mid-haul links. A transceiver in CU 613 is coupled to 5GC 630 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

In some examples, the RRC in CU 613 receives a measurement report generated by UE 601. The measurement report comprises a 5GNR RSRP for 5GNR RAN 610, the sampling rate for the 5GNR RSRP, an LTE RSRP for LTE RAN 620, and the sampling rate for the LTE RSRP. The RRC determines the difference (if any) between the sampling rates and applies the sampling rate difference to the calibration table. As illustrated in FIG. 8, the calibration table stored on the memory of CU 613 associates sampling rate differences with calibration factors. These calibration values are exemplary and may differ in other examples. The RRC selects a calibration factor from the calibration table based on the sampling rate difference indicated in the measurement report. The RRC applies the selected calibration factor to the reported 5GNR RSRP to generate a normalized 5GNR RSRP. The RRC uses the normalized 5GNR RSRP in B2 measurement events to determine when to handover UE 601 from 5GNR RAN 610 to LTE RAN 620.

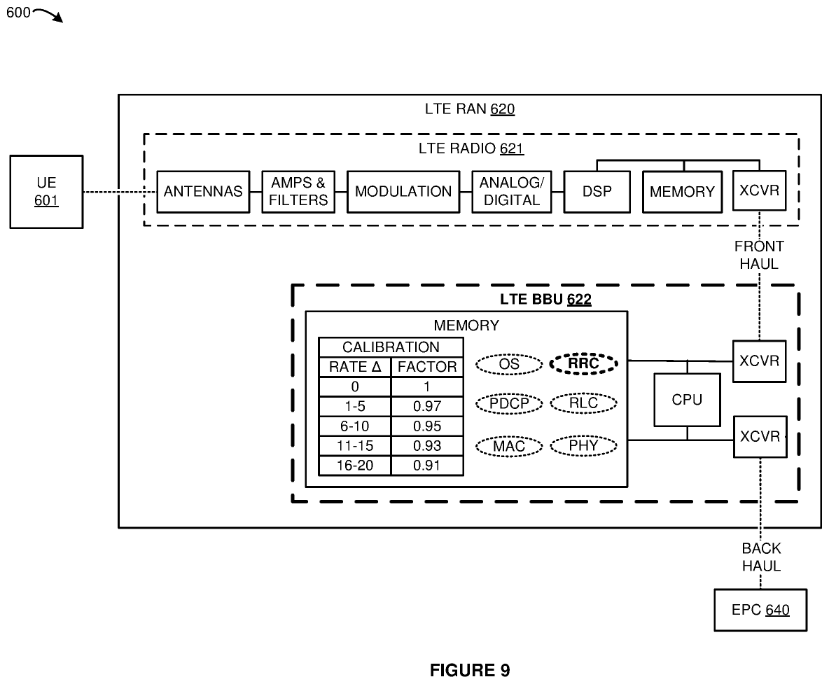

FIG. 9 illustrates LTE radio 621 and LTE BBU 622 in 5G communication network 600. LTE radio 621 and LTE BBU 622 comprise an example of access nodes 110 and 120 illustrated in FIG. 1 and LTE eNodeB 320 illustrated in FIG. 3, however access nodes 110, 120, and eNodeB 320 may differ.

LTE radio 621 comprises antennas, amplifiers, filters, modulation, analog-to-digital interfaces, DSP, memory, and transceivers (XCVRs) that are coupled over bus circuitry. UE 601 is wirelessly coupled to the antennas in LTE radio 621 over LTE links. Transceivers in LTE radio 621 are coupled to transceivers in LTE BBU 622 over fronthaul links like enhanced Common Public Radio Interface (eCPRI). The DSPs in LTE radio 621 execute their operating systems and radio applications to exchange LTE signals with UE 601 and to exchange LTE data with BBU 622.

For the uplink, the antennas receive wireless signals from UE 601 that transport uplink LTE signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding LTE symbols to BBU 622 over the transceivers.

For the downlink, the DSPs receive downlink LTE symbols from BBU 622. The DSPs process the downlink LTE symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink LTE signaling and data.

LTE BBU 622 comprises memory, CPU, and transceivers that are coupled over bus circuitry. The memory in BBU 622 stores operating systems, LTE network applications like PHY, MAC, RLC, PDCP, and RRC, and a calibration table to normalize 5GNR measurements for inter-RAT signal strength comparisons. Transceivers in BBU 622 are coupled to transceivers in LTE radio 621 over front-haul links. A transceiver in BBU 622 is coupled to EPC 640 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

In some examples, the RRC in BBU 622 receives a measurement report generated by UE 601. The measurement report comprises a 5GNR RSRP for 5GNR RAN 610, the sampling rate for the 5GNR RSRP, an LTE RSRP for LTE RAN 620, and the sampling rate for the LTE RSRP. The RRC determines the difference (if any) between the sampling rates and applies the sampling rate difference to the calibration table. As illustrated in FIG. 9, the calibration table stored on the memory of BBU 622 associates sampling rate differences with calibration factors. The RRC selects a calibration factor from the calibration table based on the determined sampling rate difference. The RRC applies the selected calibration factor to the reported 5GNR RSRP to generate a normalized RSRP. The LTE RRC uses the normalized 5GNR RSRP in B1 and B2 measurement events to determine when to add 5G RAN 610 for dual connectivity or to handover UE 601 from LTE RAN 620 to 5GNR RAN 610.

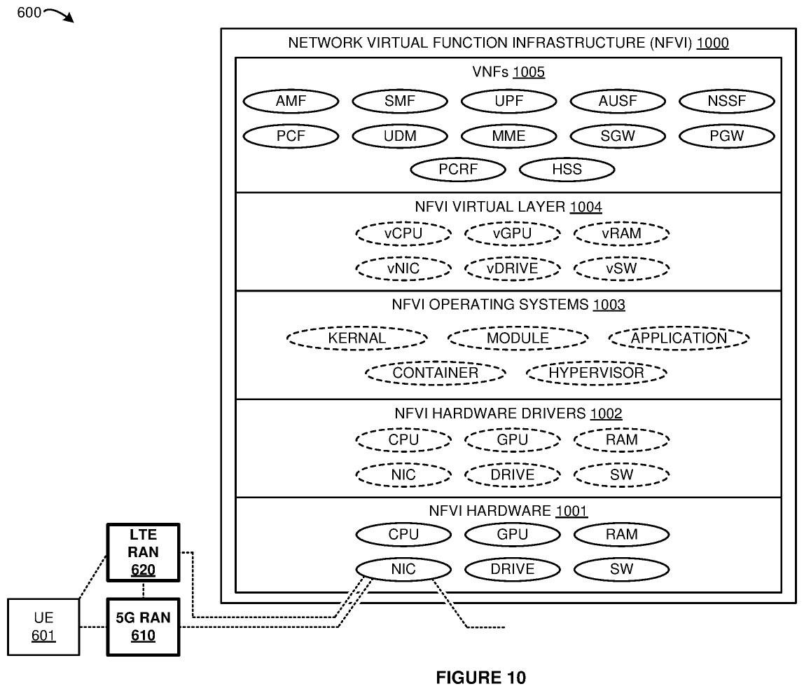

FIG. 10 illustrates Network Function Virtualization Infrastructure (NFVI) 1000. NFVI 1000 comprises an example of core network 131 illustrated in FIG. 1 and network circuitry 330 illustrated in FIG. 3, although core network 131 and network circuitry 330 may differ. NFVI 1000 comprises NFVI hardware 1001, NFVI hardware drivers 1002, NFVI operating systems 1003, NFVI virtual layer 1004, and NFVI VNFs 1005. NFVI hardware 1001 comprises Network Interface Cards (NICs), CPU, GPU, RAM, Flash/Disk Drives (DRIVE), and Data Switches (SW). NFVI hardware drivers 1002 comprise software that is resident in the NIC. CPU, GPU, RAM, DRIVE, and SW. NFVI operating systems 1003 comprise kernels, modules, applications, containers, hypervisors, and the like. NFVI virtual layer 1004 comprises vNIC, vCPU, vGPU, vRAM, vDRIVE, and vSW. NFVI VNFs 1005 comprise AMF, SMF, UPF, AUSF, NSSF, PCF, UDM, MME, SGW, PGW, PCRF, and HSS. Additional VNFs and network elements like NRF, NEF, AF, and ANDSF are typically present but are omitted for clarity. The AMF, SMF, AUSF, NSSF, PCF, UDM compose 5G control plane 631. The UPF composes 5G user plane 632. The MME, PCRF, and HSS compose LTE control plane 641. The SGW and PGW compose LTE user plane 642. NFVI 900 may be located at a single site or be distributed across multiple geographic locations. For example, NFVI 900 may be split where one portion forms 5GC 630 and other portion forms EPC 640. The NIC in NFVI hardware 1001 is coupled to 5G RAN 610, LTE RAN 620, and to external systems like data networks and application servers. NFVI hardware 1001 executes NFVI hardware drivers 1002, NFVI operating systems 1003, NFVI virtual layer 1004, and NFVI VNFs 1005 to form 5G control plane 631, 5G user plane 632, LTE control plane 641, and LTE user plane 642.

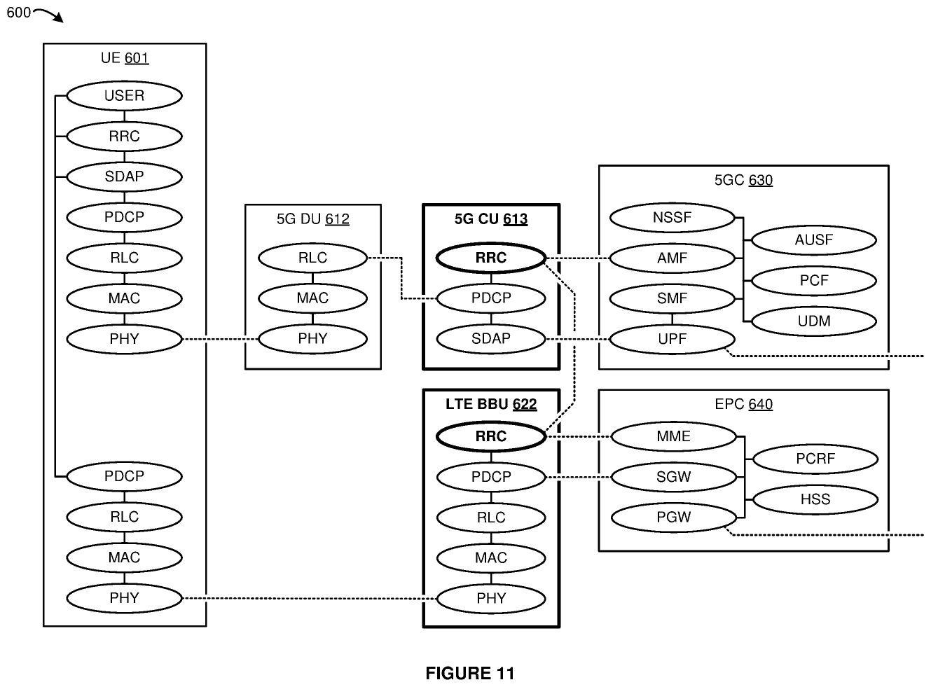

FIG. 11 illustrates an exemplary operation of 5G communication network 600 to steer a UE using a calibrated 5GNR measurement report. The operation may vary in other examples. In operation, UE 601 wirelessly attaches to LTE RAN 620. The RRC in UE 601 exchanges attachment signaling with the RRC in BBU 622 over the LTE PDCPs, RLCs, MACS, and PHYs to establish an RRC connection. The RRC in UE 601 transfers a registration request comprising a registration type, UE capabilities, requested slice types, PDU session requests, and the like. The UE capabilities indicate UE 601 comprises 5GNR and dual connectivity capabilities. The RRC in BBU 622 transfers the registration request for UE 601 to the MME in EPC 640. The MME responds to the registration request by transferring an identity request for UE 601 to the RRC in BBU 622. The RRC in BBU 622 forwards the identity request to the RRC in UE 601 over the LTE PDCPs, RLCs, MACs, and PHYs. The RRC in UE 601 transfers an identity indication to the RRC in BBU 622 over the LTE PDCPs, RLCs, MACs, and PHYs. The RRC in CU 613 transfers the identity indication to the MME. The MME interacts with the other entities in EPC 640 to authenticate and authorize UE 601 for wireless data services.

Responsive to the authentication and authorization, the MME generates UE context comprising QoS metrics, slice IDs, service attributes, network addresses, and the like. The MME transfers the UE context to the RRC in BBU 622. The RRC in BBU 622 transfers the UE context to the RRC in UE 601 over the LTE PDCPs, RLCs, MACs, and PHYs. In response to the execution of the user application, the RRC in UE 601 uses the UE context to initiate a data session over LTE RAN 620 and EPC 640. The user application generates user data. The LTE PDCP in UE 601 exchanges the user data with the PDCP in BBU 622 over the LTE RLCs, MACs, and PHYs. The PDCP in BBU 622 exchanges the user data with the SGW and PGW in EPC 640. The SGW and PGW exchange the user data with external systems.

As UE 601 moves around, the received signal strengths for 5G RAN 610 and LTE RAN 620 vary. To detect handover and dual connectivity conditions, the RRC in BBU 622 controls the MAC in BBU 622 to continuously generate CRS resource blocks. The MAC in BBU 622 broadcasts the CRS resource blocks over the PHY. Likewise, the RRC in CU 613 controls the MAC in DU 612 to periodically generate CSI and SS resource blocks. The MAC in DU 612 broadcasts the CSI and SS resource blocks over the PHY. The RRC in UE 601 receives the CRS resource blocks over the LTE PDCPs, RLCs, MACs, and PHYs and receives the CSI and SS resource blocks over the 5GNR PDCPs, RLCs, MACs, and PHYs. The RRC controls the LTE PHY to measure LTE RSRP based on CSR resource blocks to determine received signal strength for LTE RAN 620. The RRC controls the 5GNR PHY to synchronize with 5G RAN 610 using the SS resource blocks and measure 5GNR RSRP based on the CSI resource blocks to determine received signal strength for 5GNR RAN 610. The RRC tracks the number of samples used to generate the 5GNR RSRP and the number of samples used to generate the LTE RSRP. The RRC generates a measurement report comprising 5GNR RSRP, the 5GRN sampling rate, the LTE RSRP, and the LTE sampling rate and transfers the measurement report over the LTE PDCPs RLCs, MACs, and PHYs to the RRC in BBU 622.

The RRC in BBU 622 reads the measurement report to determine a sampling rate difference between the 5GNR RSRP and the LTE RSRP. The RRC accesses the calibration table stored in BBU 622 to select a calibration factor based on the sampling rate difference. The RRC multiples 5GNR RSRP with the selected calibration factor to normalize the measured 5GNR RSRP. The RRC compares the normalized 5GNR RSRP and LTE RSRP to a B2 handover threshold and compares the normalized 5GNR RSRP to a B1 addition threshold. At this point, the LTE RSRP is sufficiently strong and does not trigger the B2 threshold while the normalized 5GNR RSRP is large enough to trigger the B1 threshold. Consequently, the RRC determines that B2 threshold is not triggered and that the B1 threshold is triggered. In response and based on dual connectivity and 5GNR capabilities of UE 601, the RRC in BBU 622 transfers an addition command to the RRC in UE 601 over the LTE PDCPs, RLCs, MACs, and PHYs. The RRC in BBU 622 directs the RRC in CU 613 to serve UE 601 over their X2 interface.

In response to the addition command, UE 601 wirelessly attaches to 5G RAN 610. The RRC in UE 601 transfers a registration request to the RRC in CU 613 over the 5GNR PDCPs, RLCs, MACs, and PHYs. The RRC in CU 613 transfers the registration request for UE 601 to the AMF in 5GC 630. The AMF responds to the registration request by transferring an identity request for UE 601 to the RRC in CU 613 which forwards the request to the RRC in UE 601 over the 5GNR PDCPs, RLCs, MACs, and PHYs. The RRC in UE 601 transfers an identity indication to the RRC in CU 613 over the PDCPs, RLCs, MACs, and PHYs. The RRC in CU 613 transfers the identity indication to the AMF. The AMF interacts with the other network functions in 5GC 630 to authenticate and authorize UE 601 for wireless data services. In some examples, the MME in EPC 640 may instead transfer UE context and registration information for UE 601 to the AMF in 5GC 630 to obviate the need for UE 601 to exchange registration signaling with the AMF.

Responsive to the authentication and authorization, the AMF generates UE context for UE 601. The AMF transfers the UE context to the RRC in CU 613. The RRC in CU 613 transfers the UE context to the RRC in UE 601 over the 5GNR PDCPs, RLCs, MACs, and PHYs. The executing user application in UE 601 generates additional user data. The SDAP in UE 601 controls the distribution of user data transfer between the 5GNR and LTE links. The SDAP exchanges the 5GNR portion of the user data over the 5GNR PDCPs, RLCs, MACs, and PHYs with the SDAP in CU 613. The SDAP in CU 613 exchanges the 5GNR portion of user data with the UPF in 5GC 630. The UPF exchanges the 5GNR portion of the user data with external systems. The PDCP in UE 601 exchanges the LTE portion of the user data over the LTE RLCs, MACs, and PHYs with the PDCP in BBU 622. The PDCP in BBU 622 exchanges the LTE portion of user data with the SGW and PGW in EPC 640. The SGW and PGW exchange the LTE portion of the user data with external systems.

UE 601 continues to move around and the received signal strengths for 5G RAN 610 and LTE RAN 620 continue to vary. The RRC in BBU 622 controls the MAC in BBU 622 to generate additional CRS resource blocks and broadcast the CRS resource blocks over the PHY. Likewise, the RRC in CU 613 controls the MAC in DU 612 to generate additional CSI and SS resource blocks and broadcast the CSI and SS resource blocks over the PHY. The RRC in UE 601 receives the additional CRS resource blocks over the LTE PDCPs, RLCs, MACs, and PHYs and receives the additional CSI and SS resource blocks over the 5GNR PDCPs, RLCs, MACs, and PHYs. The RRC controls the PHYs to measure LTE RSRP and 5GNR RSRP based on the CRS and CSI resource blocks. The RRC tracks the number of samples used to generate the 5GNR RSRP and the number of samples used to generate the LTE RSRP. The RRC generates a subsequent measurement report comprising the subsequent 5GNR RSRP, the subsequent 5GRN sampling rate, the subsequent LTE RSRP, and the subsequent LTE sampling rate. The RRC transfers the subsequent measurement report over the LTE PDCPs RLCs, MACs, and PHYs to the RRC in BBU 622.

The RRC in BBU 622 determines the sampling rate difference between the 5GNR RSRP and the LTE RSRP. The RRC selects a calibration factor based on the sampling rate difference from the stored calibration table. The RRC normalizes the measured 5GNR RSRP using the selected calibration factor. The RRC applies the subsequent normalized 5GNR RSRP and subsequent LTE RSRP to the B2 handover threshold and compares the subsequent normalized 5GNR RSRP to the B1 addition threshold. At this point, the subsequent LTE RSRP and the normalized 5GNR RSRP triggers the B2 handover threshold. In response and based on the 5GNR capability of UE 601, the RRC in BBU 622 transfers a handover command to the RRC in UE 601 over the LTE PDCPs, RLCs, MACs, and PHYs. The RRC in BBU 622 indicates the handover to RRC in CU 613 over their X2 interface. In response to the handover command, UE 601 detaches from LTE RAN 620 and maintains its connection and data session with 5G RAN 610.

The wireless data network circuitry described above comprises computer hardware and software that form special-purpose network circuitry to steer wireless user devices using calibrated measurement reports. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to steer wireless user devices using calibrated measurement reports.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless access node to steer a wireless user device to a Radio Access Technology (RAT) type, the method comprising:
wirelessly receiving a measurement report from a wireless user device that comprises a first measured signal strength for a first RAT type and a second measured signal strength for a second RAT type wherein a first sampling rate for the first measured signal strength is different than a second sampling rate for the second measured signal strength;
applying a calibration factor to the second measured signal strength to normalize the second measured signal strength with the first measured signal strength;
comparing the normalized second measured signal strength to the first measured signal strength; and
wirelessly transferring an attachement instruction to the wireless user device to attach the to the first RAT type or the second RAT type based on the comparison.

2. The method of claim 1 wherein applying the calibration factor to the second measured signal strength comprises modifying the second measured signal strength based on the difference between the first sampling rate and the second sampling rate to generate the normalized second measured signal strength.

3. The method of claim 1 further comprising accessing a calibration factor table to determine the calibration factor based on the difference between the first sampling rate and the second sampling rate.

4. The method of claim 1 wherein wirelessly transferring an attachement instruction to the wireless user device to attach to the first RAT type or the second RAT type based on the comparison comprises:
wirelessly transferring the attachement instruction that directs the wireless user device to attach to the first RAT type when the first measured signal strength exceeds the normalized second measured signal strength; and
wirelessly transferring the attachement instruction that directs the wireless user device to attach to the second RAT type when the normalized second measured signal strength exceeds the first measured signal strength.

5. The method of claim 1 wherein:
receiving the first measurement report and the second measurement report from the wireless user device comprises receiving a B2 measurement report that comprises the first measured signal strength and the second measured signal strength; and
comparing the normalized second measured signal strength to the first measured signal strength comprises comparing the first measured signal strength and the normalized second measured signal strength to a B2 handover threshold.

6. The method of claim 1 wherein:
receiving the first measurement report and the second measurement report from the wireless user device comprises receiving a B1 measurement report that comprises the first measured signal strength and the second measured signal strength; and
comparing the normalized second measured signal strength to the first measured signal strength comprises comparing the normalized second measured signal strength to a B1 addition threshold.

7. The method of claim 1 wherein the first RAT type comprises Long Term Evolution (LTE) and the second RAT type comprises Fifth Generation New Radio (5GNR).

8. A wireless access node configured to steer a wireless user device to a Radio Access Technology (RAT) type, the wireless access node comprising:
radio circuitry configured to wirelessly receive a measurement report from a wireless user device that comprises a first measured signal strength for a first RAT type and a second measured signal strength for a second RAT type wherein a first sampling rate for the first measured signal strength is different than a second sampling rate for the second measured signal strength;
node circuitry configured to apply a calibration factor to the second measured signal strength to normalize the second measured signal strength with the first measured signal strength;
the node circuitry configured to compare the normalized second measured signal strength to the first measured signal strength; and
the radio circuitry configured to wirelessly transfer an attachement instruction to the wireless user device to attach to the first RAT type or the second RAT type based on the comparison.

9. The wireless access node of claim 8 wherein the node circuitry is configured to modify the second measured signal strength based on the difference between the first sampling rate and the second sampling rate to generate the normalized second measured signal strength.

10. The wireless access node of claim 9 wherein the node circuitry is further configured to access a calibration factor table to determine the calibration factor based on the difference between the first sampling rate and the second sampling rate.

11. The wireless access node of claim 8 wherein:
the radio circuitry is configured to wirelessly transfer the attachement instruction that directs the wireless user device to attach to the first RAT type when the first measured signal strength exceeds the normalized second measured signal strength; and
the radio circuitry is configured to wirelessly transfer the attachement instruction that directs the wireless user device to attach to the second RAT type when the normalized second measured signal strength exceeds the first measured signal strength.

12. The wireless access node of claim 8 wherein:
the radio circuitry is configured to receive a B2 measurement report that comprises the first measured signal strength and the second measured signal strength; and
the node circuitry is configured to compare the first measured signal strength and the normalized second measured signal strength to a B2 handover threshold.

13. The wireless access node of claim 8 wherein:
the radio circuitry is configured to receive a B1 measurement report that comprises the first measured signal strength and the second measured signal strength; and
the node circuitry is configured to compare the normalized second measured signal strength to a B1 addition threshold.

14. The wireless access node of claim 8 wherein the first RAT type comprises Long Term Evolution (LTE) and the second RAT type comprises Fifth Generation New Radio (5GNR).

15. One or more non-transitory computer-readable storage media having program instructions stored thereon to steer a wireless user device to a Radio Access Technology (RAT) type, wherein the program instructions, when executed by a computing system, direct the computing system to perform operations, the operations comprising:
receiving a measurement report from a wireless user device that comprises a first measured signal strength for a first RAT type and a second measured signal strength for a second RAT type wherein a first sampling rate for the first measured signal strength is different than a second sampling rate for the second measured signal strength;
applying a calibration factor to the second measured signal strength to normalize the second measured signal strength with the first measured signal strength;
comparing the normalized second measured signal strength to the first measured signal strength; and
transferring an attachement instruction to the wireless user device to attach to the first RAT type or the second RAT type based on the comparison.

16. The non-transitory computer-readable storage media of claim 15 wherein the operations comprise modifying the second measured signal strength based on the difference between the first sampling rate and the second sampling rate to generate the normalized second measured signal strength.

17. The non-transitory computer-readable storage media of claim 16 wherein the operations further comprise accessing a calibration factor table to determine the calibration factor based on the difference between the first sampling rate and the second sampling rate.

18. The non-transitory computer-readable storage media of claim 15 wherein the operations further comprise transferring the attachement instruction that directs the wireless user device to attach to the first RAT type when the first measured signal strength exceeds the normalized second measured signal strength and transferring the attachement instruction that directs the wireless user device to attach to the second RAT type when the normalized second measured signal strength exceeds the first measured signal strength.

19. The non-transitory computer-readable storage media of claim 15 wherein the operations comprise:
receiving a B2 measurement report that comprises the first measured signal strength and the second measured signal strength; and
comparing the first measured signal strength and the normalized second measured signal strength to a B2 handover threshold.

20. The non-transitory computer-readable storage media of claim 15 wherein the operations comprise:
receiving a B1 measurement report that comprises the first measured signal strength and the second measured signal strength; and
comparing the normalized second measured signal strength to a B1 addition threshold.
